(19) United States
(12) Patent Application Publication
(10) Pub. No.: US 2025/0356270 A1
(43) Pub. Date: Nov. 20, 2025

(54) SYSTEMS AND METHODS FOR AN ELECTRONIC PARKING SPACE MARKETPLACE

(71) Applicants: James R. HOHENLOHE, Breckenridge, CO (US); Erik K. DAVISON, South Elgin, IL (US); Ben D. RAY, Denver, CO (US)

(72) Inventors: James R. HOHENLOHE, Breckenridge, CO (US); Erik K. DAVISON, South Elgin, IL (US); Ben D. RAY, Denver, CO (US)

(21) Appl. No.: 19/212,161

(22) Filed: May 19, 2025

Related U.S. Application Data
(60) Provisional application No. 63/648,874, filed on May 17, 2024.

(51) Int. Cl. G06Q 10/02; G06Q 50/12; G08G 1/14

(52) U.S. Cl. CPC G06Q 10/02; G06Q 50/12; G08G 1/144; G08G 1/146

(57) ABSTRACT

A parking reservation system that is configured to: receive, via a user device, user data and at least one user request for a parking reservation; identify using the at least one user request for the parking reservation, one or more parking spaces that meet criteria defined in the at least one user request for the parking reservation; retrieve, from a database, availability information of the one or more parking spaces; provide, at a user interface on the user device, the availability of the one or more parking spaces; receive, via the user interface on the user device, a parking space selection, the parking space selection indicating a desired parking space of the one or more parking spaces; and secure, via a digital market place, the desired parking space associated with the parking space selection based on the user data and the at least one user request for the parking reservation.

### CROSS REFERENCE TO RELATED APPLICATIONS

This U.S. Non-Provisional patent application claims the benefit of U.S. Provisional Patent Application Ser. No. 63/648,874 filed May 17, 2024, the entire disclosure of which is hereby incorporated by reference.

### TECHNICAL FIELD

This disclosure relates to parking space reservations, and, in particular to systems and methods for an electronic parking space marketplace.

### BACKGROUND

Traveling, whether for business or pleasure, for a day or for an extended period, often involves parking a vehicle, either short term at a venue, long term at a rental location or hotel, or any suitable period. Typically, in locations of high traffic, particularly during peak attendance (e.g., at a ski resort during peak skiing season, for example), it is difficult to locate a parking space on arrival. Additionally, owners of such parking spaces may desire to monetize available parking by renting such parking spaces to those seeking to secure a parking space.

### SUMMARY

An aspect of the disclosed embodiment includes a system that includes: a processor; and a memory including instructions that, when executed by the processor, cause the processor to: receive, via a user device, user data and at least one user request for a parking reservation; identify using the at least one user request for the parking reservation, one or more parking spaces that meet criteria defined in the at least one user request for the parking reservation; retrieve, from a database, availability information of the one or more parking spaces; provide, at a user interface on the user device, the availability of the one or more parking spaces; receive, via the user interface on the user device, a parking space selection, the parking space selection indicating a desired parking space of the one or more parking spaces; and secure, via a digital market place, the desired parking space associated with the parking space selection based on the user data and the at least one user request for the parking reservation.

Another aspect of the disclosed embodiments includes a method that includes: receiving, via a user device, user data and at least one user request for a parking reservation; identifying using the at least one user request for the parking reservation, one or more parking spaces that meet criteria defined in the at least one user request for the parking reservation; retrieving, from a database, availability information of the one or more parking spaces; providing, at a user interface on the user device, the availability of the one or more parking spaces; receiving, via the user interface on the user device, a parking space selection, the parking space selection indicating a desired parking space of the one or more parking spaces; and securing, via a digital market place, the desired parking space associated with the parking space selection based on the user data and the at least one user request for the parking reservation.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a parking reservation system, according to the principles of the present disclosure.

FIG. 2 generally illustrates a parking reservation flow diagram, according to the principles of the present disclosure.

FIG. 3 is an example block diagram of a processor-based computer system, according to the principles of the present disclosure.

FIG. 4 is a flow diagram generally illustrating a parking reservation method, according to the principles of the present disclosure.

### DETAILED DESCRIPTION

Reference will now be made in detail to example embodiments which are illustrated in the accompanying drawings, wherein like reference numerals refer to like elements throughout. In this regard, the example embodiments may have different forms and may not be construed as being limited to the descriptions set forth herein.

It will be understood that the terms “include,” “including,” “comprise,” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be further understood that, although the terms “first,” “second,” “third,” etc., may be used herein to describe various elements, components, regions, layers and/or sections, these elements, components, regions, layers and/or sections may not be limited by these terms. These terms are only used to distinguish one element, component, region, layer or section from another element, component, region, layer or section.

As used herein, the term “and/or” includes any and all combinations of one or more of the associated listed items. Expressions such as “at least one of,” when preceding a list of elements, modify the entire list of elements and do not modify the individual elements of the list.

Various terms are used to refer to particular system components. Different companies may refer to a component by different names—this document does not intend to distinguish between components that differ in name but not function.

Matters of these example embodiments that are obvious to those of ordinary skill in the technical field to which these example embodiments pertain may not be described herein in detail.

It may be understood that the example embodiments described herein may be considered in a descriptive sense only and not for purposes of limitation. Descriptions of features or aspects within each example embodiment may be considered as available for other similar features or aspects in other example embodiments.

As described, traveling, whether for business or pleasure, for a day or for an extended period, often involves parking a vehicle, either short term at a venue, long term at a rental location or hotel, or any suitable period. Typically, in locations of high traffic, particularly during peak attendance (e.g., at a ski resort during peak skiing season, for example), it is difficult to locate a parking space on arrival. Additionally, owners of such parking spaces may desire to monetize available parking by renting such parking spaces to those seeking to secure a parking space.

Accordingly, systems and methods, such as those described herein, configured to provide users with an ability to secure a parking space in advance of arrival and to allow owners of parking spaces to monetize their available spaces, may be desirable. In some embodiments, the systems and methods described herein may be configured to provide an algorithm and technical framework that are tailored to redefine parking reservations, with a specific focus on enhancing the experience for travelers or day users at various locations. The systems and methods described herein may be configured to provide a web-interface, mobile application, and/or the like.

The systems and methods described herein may be configured to provide a seamless intuitive desktop experience coupled with a responsive mobile version takes full advantage of a mobile-first mentality given the nature of information regarding real-time parking mobility. The systems and methods described herein may be configured to provide a strategic position that aims to cater to a wide audience by providing accessibility across different devices and platforms.

The systems and methods described herein may be configured to provide an integrated platform designed to cater to the unique needs of drivers seeking parking passes for 1, 10, 30, or any suitable number of trips to the parking space for a given period. To maximize user convenience, the systems and methods described herein may be configured to provide a seamless account creation process, across all devices, enabling efficient pre-booking and post-reservation account setups. The systems and methods described herein may be configured to allow drivers to easily navigate through spot inventory, focused on location and price, facilitating same-day bookings with flexible pass options for varying durations, simplifying the reservation and management process.

In some embodiments, the systems and methods described herein may be configured to provide, for priority owners, a meticulous account creation process for the hosts, which seamlessly integrates luxury premium lodges, along with other large properties such. These partnerships ensure exclusive benefits for parking pass holders, with property hosts having the ability to add parking spaces based on availability preferences. The systems and methods described herein may be configured to prioritize pass holders for reservations, fostering a transparent revenue-sharing model that guarantees monthly payments to property owners. This mutually beneficial relationship is further enhanced through partnerships with municipal parking management, and other municipal entities including local law enforcement and the local parking task forces, offering ease of integration into local laws, policies, and procedures.

In some embodiments, the systems and methods described herein may be configured to extend to user-friendly interfaces for both drivers and property owners, accessible through the mobile applications, desktop, and responsive mobile versions. Drivers benefit from easy navigation of parking spots, reservation creation, and cancellation flexibility, while parking hosts have access to a backend admin system for seamless management of reservations, dynamic pricing, and earnings tracking.

By incorporating dynamic pricing strategies emphasizing a revenue-sharing model, the systems and methods described herein may be configured to provide a revolutionary platform that enhances parking reservation experiences for both drivers and hosts. The systems and methods described herein may be configured to provide improved user convenience, strategic partnerships, revenue generation, and technological advancement positions to provide a groundbreaking platform that revolutionizes parking reservation experiences for both drivers and property owners.

In some embodiments, the systems and methods described herein may be configured to leverage blockchain technology to secure parking reservation data, ensure tamper-proof records, and enhance data privacy. The systems and methods described herein may be configured to provide enhanced data security within the parking reservation industry.

The systems and methods described herein may be configured to use a system of artificial intelligence (AI) for personalized parking recommendations. By utilizing AI algorithms to analyze user behavior and preferences, the systems and methods described herein may be configured to offer tailored parking suggestions to drivers, enhancing their overall experience and increasing user engagement. This unique feature not only adds a layer of sophistication to the systems and methods described herein, but may also set a new standard for personalized parking services.

In some embodiments, the systems and methods described herein may be configured to leverage geo-fencing technology, which may be highly effective in targeting drivers within specific geographic areas and may deliver personalized promotions or discounts directly to mobile devices. Additionally, or alternatively, the systems and methods described herein may be configured to utilize cookie advertising to retarget website visitors with tailored ads, SMS messaging for real-time communication with users, and in-app messaging for proactive engagement, which may create a comprehensive marketing approach that maximizes user reach and engagement. By combining these innovative marketing tactics with the advanced functionalities of the systems and methods described herein, the systems and methods described herein may be configured to effectively capture the attention of its target audience and establish itself as a leader in the parking reservation industry.

In some embodiments, the systems and methods described herein may be configured to provide scalability, viability, and a competitive advantage expanding into new markets, which may be a crucial strategy for growth and success. The systems and methods described herein may be configured to, in addition to geographical expansions, incorporate user feedback-driven features and collaborating with key industry players to enhance competitiveness and long-term sustainability.

In some embodiments, the systems and methods described herein may be configured to incorporate the boat slips industry and interact with organizations such as marina operators or waterfront property developers.

In some embodiments, the systems and methods described herein may be configured to provide enhanced parking-as-a-service (PaaS) and AI integration. The systems and methods described herein may be configured to create a comprehensive ecosystem that not only optimizes parking capacity and revenue but also enhances the entire user journey through AI-driven recommendations and voice-activated discovery.

The systems and methods described herein may be configured to provide a PaaS platform that includes a comprehensive, multi-tenant, white-labeled cloud-based parking management solution for property owners/operators, hotels, resorts, municipalities, casinos, and stadiums. The systems and methods described herein may be configured to provide an AI merchant integration system comprising an AI-driven, voice-enabled ecosystem connecting parking with precision geo-targeted merchant discovery, incentives, and recommendations.

The PaaS system establishes a white-labeled, cloud-based parking management ecosystem including: Multi-Tenant Infrastructure: Proprietary cloud platform with dedicated instances for each property operator, allowing complete brand customization while maintaining centralized management; Reservation System Technology: Real-time availability tracking algorithm managing parking inventory across multiple facilities with dynamic pricing capabilities; Authentication & Access Control: QR code-based verification system integrating with existing property management systems while maintaining security protocols; and Revenue Distribution Mechanism: Automated 70/30 revenue sharing system (70% to property owner, 30% to platform) with detailed reporting capabilities. The systems and methods described herein may be configured to use a tiered service model.

The systems and methods described herein may be configured to use various advanced AI components. For example, the systems and methods described herein may be configured to use a sponsored predictive model comprising: an AI engine for analyzing transaction data between merchants and customers to predict the likelihood of parking incentives driving specific merchant transactions; machine learning capabilities improving prediction accuracy over time; and cross-property pattern recognition identifying user preferences across multiple venues.

In some embodiments, the systems and methods described herein may be configured to use Geo-Targeted Voice Assistant Technology, which may include: Precision geo-targeting using GPS, Wi-Fi triangulation, and Bluetooth beacon detection to pinpoint a user's exact location with street-level accuracy; Natural language contextual interactions such as “We notice you're at the corner of Bridge Street and Gore Creek Drive in Vail. On your left is La Bottega, which specializes in Italian cuisine and has a 4.8-star rating. Would you like me to check if they have a table available?”; and Seamless merchant integration flow that: Directly interfaces with reservation systems upon user confirmation; Provides real-time feedback (“They have a table for two at 7:30 PM”); Facilitates immediate booking through voice confirmation; and Automatically sends a text confirmation with details and directions.

In some embodiments, the systems and methods described herein may be configured to use a Preference-Based Recommendation Engine that: uses a Conversational AI interface enabling drivers to receive contextually relevant recommendations like, “Since you parked at the Abella property with pool and spa access, you might enjoy Bear River which offers similar amenities. Nearby merchants include Peak Bistro and Mountain Tavern and Grill. Would you like me to help with parking reservations there or suggest other local businesses?”; and Creates a closed-loop system between parking facilities and retail businesses.

In some embodiments, the systems and methods described herein may be configured to provide an advanced content and data architecture. For example, the systems and methods described herein may be configured to use a large language model (LLM) optimized content architecture that includes: Semantic Relationship Mapping (e.g., Unlike traditional SEO that relies on keyword density, the systems and methods described herein may be configured to build interconnected semantic graphs of concepts, entities, and relationships between parking locations, merchant offerings, and user preferences, enabling LLMs to understand the full contextual landscape; Conversational Intent Modeling (e.g., the systems and methods described herein may be configured to analyze and categorize user queries based on underlying intent patterns rather than keywords, distinguishing between navigational, informational, and transactional intents for highly relevant responses; and Contextual Information Structuring (e.g., content is organized in nested information hierarchies that align with how LLMs process information, establishing primary concepts with supporting details retrievable based on conversational context).

In some embodiments, the systems and methods described herein may be configured to use Multi-Turn Conversation Management. The systems and methods described herein may be configured to maintain contextual thread awareness across multiple interactions, allowing users to refine parking queries without restating preferences. The systems and methods described herein may be configured to process full conversational queries (e.g., averaging 29 words versus 3-4 for text search). The systems and methods described herein may be configured to analyze speech patterns including tone and stress to detect urgency in requests.

In some embodiments, the systems and methods described herein may be configured to provide Consumer Affinity Prediction, which may: provide a data mining capability processing transaction patterns to determine consumer preferences; Recommend relevant merchant incentives based on historical behavior; and Create personalized offers that increase conversion rates for parking and retail purchases.

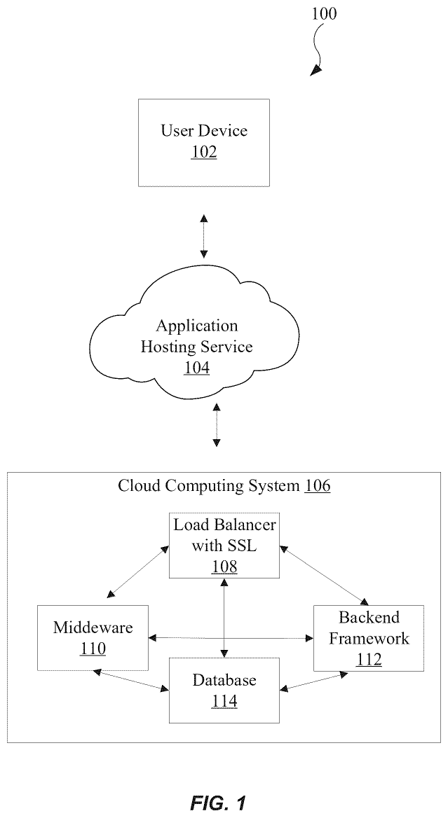

With reference to FIG. 1, a parking reservation system 100 is generally illustrated. The system 100 may include a data sharing architecture, which may include: Secure application programming interface (API) connections between parking management and merchant recommendation systems; Real-time data synchronization enabling immediate merchant recommendations based on location; and Privacy-compliant data management ensuring user consent for recommendations

The system 100 may include a user device 102. The user device 102 may include any suitable computing device, such as a mobile computing device, desktop computing device, and/or the like. The user device 102 may be configured to receive and transmit data via an application, which the user device 102 may interact with and/or download via an application hosting service 104. The application may be a desktop application, mobile application, and/or the like. The application may be configured to provide a unified user experience comprising: seamless transition between parking reservations and merchant discovery; single authentication for both parking and merchant interactions; and consistent branding and user interface across all touchpoints.

The system 100 may be configured to pride combined analytics, such as: Holistic reporting on user journeys from parking through merchant interactions; Attribution modeling connecting parking decisions to merchant revenue; and Predictive analytics forecasting parking demand based on merchant promotions.

The system 100 may include a cloud computing system 106. The cloud computing system 106 may be hosted on distributed cloud infrastructure for maximum reliability. The cloud computing system 106 may use a micro-services design enabling independent scaling of different components. The cloud computing system 106 may use geographically redundant data centers ensuring 99.9% uptime.

The cloud computing system 106 may include a load balancer 108 with secure socket layer (SSL) for providing request and response load balancing to and from the application. The cloud computing system 106 may include a middleware 110, a backend framework 112, and a database (e.g., or databases) 114.

The cloud computing system 106 may be configured to use a data security framework that: provides end-to-end encryption of all user data; provides regular security audits and penetration testing; and provides compliance with relevant data protection regulations.

The system 100 may be configured to provide integration capabilities, such as: Standard API connections to property management systems; Integration with payment processors; Voice assistant platform connections (Perplexity, other LLM-based assistants); and Local merchant POS system integrations.

In some embodiments, the system 100 may be configured to provide a unified, white-labeled, multi-tenant parking management platform with tiered service model. The system 100 may be configured to provide an AI-driven, voice-activated merchant recommendation engine with precision geo-targeting. The system 100 may be configured to provide an LLM-optimized semantic content architecture for discovery by AI agents rather than search engines. The system 100 may be configured to provide a cross-property intelligence system identifying patterns across multiple venues and merchants. The system 100 may be configured to provide a closed-loop ecosystem connecting parking decisions with merchant interactions and incentives.

In some embodiments, the system 100 may be configured to provide API/Architecture Support. For example, all user authentication and sensitive actions (login, registration, password reset) are handled via secure, token-based endpoints over hypertext transfer protocol secure (HTTPS), supporting risk mitigation.

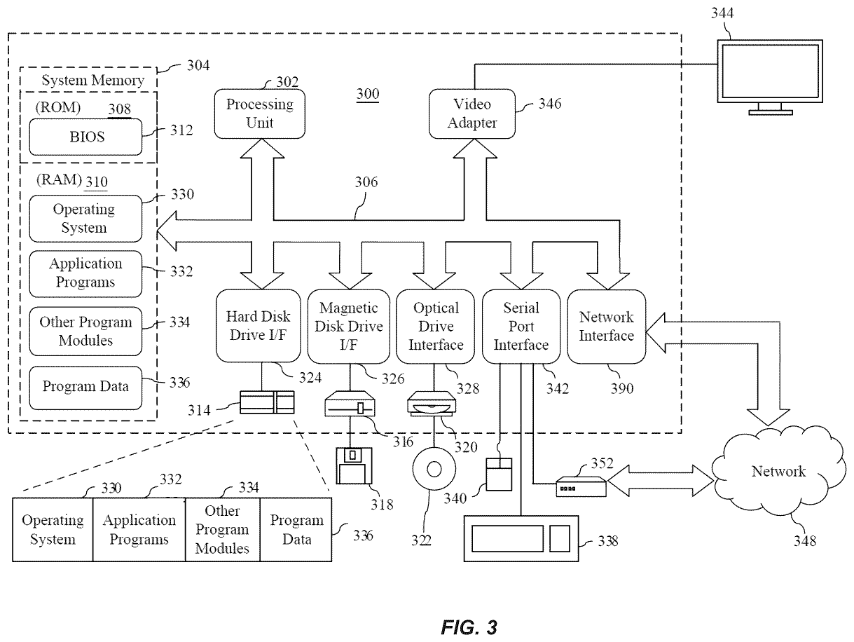

The user device 102, hosting service 104, and/or the cloud computing system 106 may include or comprise one or more computing devices or systems such as the computing system 300, generally illustrated in FIG. 3, and/or any suitable computing device or system.

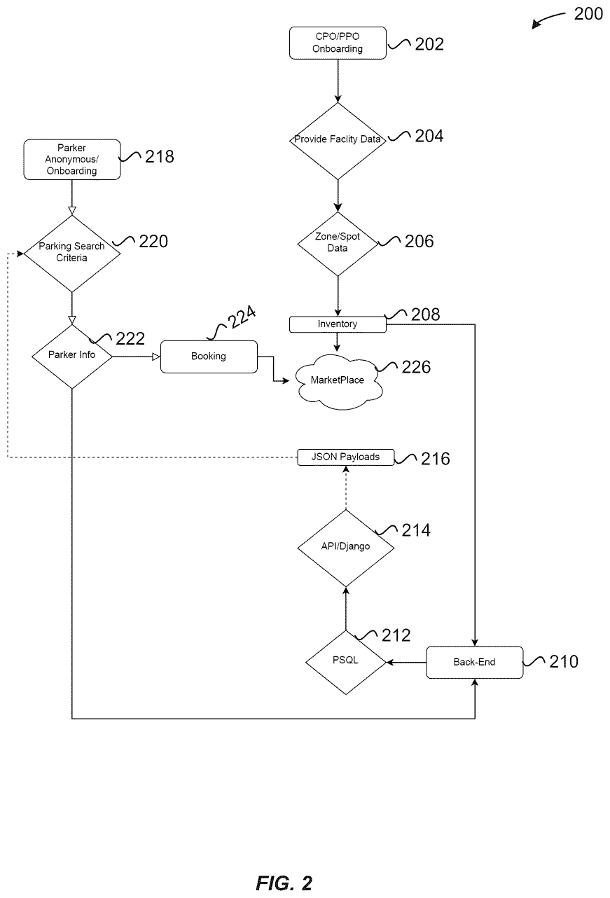

With reference to FIG. 2, a parking reservation method 200, is generally illustrated. Step 202 may provide user authentication and account management. For example, at 202, the method 200 may allow users to register, log in, refresh tokens, and reset passwords via dedicated API endpoints. Role-based access is enforced at registration, supporting multiple user types (e.g., parker, owner, admin). The user device 102 or other suitable user device may be configured to perform the functions at step 202. For example, the user device 102 may interact the backend API 112. The user device 102 may provide secure, stateless authentication; token blacklisting for logout enhances security; and email verification and password reset flows, which are integrated for compliance and user trust.

At step 204, the method 200 may allow users to search for available spots/lots, filter by facility, event, date, and amenities (including electric vehicle (EV) charging). Facility and spot data include geolocation, amenities, and custom instructions. Additionally, or alternatively, the system 100 may provide, at step 204, real-time search with granular filters, including EV infrastructure and vehicle compatibility; and, at 206, a data model that supports both individual spots and grouped zones/lots, enabling flexible inventory management, at 208. A frontend initiates search queries; and the backend processes, at 210, returns filtered results, found at step 212 (e.g., using a suitable database, such as a PostgreSQL (PSQL) database), which may interact, at step 214, with an API, which uses payloads at step 216 to search parking search criteria at step 220.

At step 222, the method 200 may perform reservation and payment punctuality. For example, at step 222, users create reservations by specifying check-in/out, vehicle details, and payment. At step 224, orders are created and tracked, with digital receipts and status updates, using a marketplace at step 226 to identify pricing and availability and to secure the reservations. Reservation requests are received at the frontend transmitted to the backend. Payment processing may be handled via integrated gateways. A reservation model may support both spots and zones, with metadata for advanced features (e.g., EV, over height vehicles). The system 100 may be integration-ready for dynamic pricing and penalty calculation logic.

With further reference to FIG. 1, the system 100 may be configured to provide owner and/or team management. Owners manage facilities, spots/lots, team members, and packages via API. Team members are assigned roles and facilities, supporting business operations at scale. The system 100 may provide an owner dashboard (frontend) that interacts with backend for operations on assets and personnel. The system 100 may provide multi-role, multi-facility management via API. The system 100 may use team management endpoints to streamline onboarding and permissions.

In some embodiments, the system 100 may provide vehicle management functionality. For example, parkers may, using the system 100, add/update vehicles (make, model, color, license, EV status). The system 100 may support multiple vehicles per user, including EV-specific attributes for future integrations.

In some embodiments, the system 100 may be configured to provide support and/or to receive feedback. For example, users may, using the system 100, access support and frequently asked questions (FAQ) resources. Additionally, or alternatively, owners and parkers may, using the system 100, submit and track support requests. The system 100 may provide a structured support model, AI-driven triage and analytics.

In some embodiments, the system 100 may be configured to provide a dynamic reservation model that includes or provides unified support for spot and zone reservations, including advanced vehicle and amenity attributes. The system 100 may be configured to provide role-based multi-tenancy, which allows owners to manage multiple facilities and teams, enabling B2B and B2C scalability. The system 100 may be configured to provide secure, stateless authentication with token blacklisting and email verification. The system 100 may be configured to provide granular search and filtering, which may include a real-time, attribute-driven search for spots/lots, including EV and over height support. The system 100 may be configured to provide extensible metadata, using reservation and facility models designed for future enhancements (dynamic pricing, IoT integration).

In some embodiments, the system 100 may be configured to: provide terms and conditions by clearly communicating user responsibilities, company limitations, and data security practices; provide data privacy by securely handling of user data (PII, vehicle info) via HTTPS and token-based authentication; and provide dispute resolution using an API that supports tracking of orders, reservations, and support tickets for transparency.

As shown in FIG. 3, processor-based computer system 300 includes one or more processors, referred to as processor circuit 302, a system memory 304, and a bus 306 that couples various system components including system memory 304 to processor circuit 302. The system 300 may be configured to interact with the system 100, the system 200, or a combination thereof to perform various aspects of the systems and methods described herein. The system 300 may be configured to implement some or all of the aspect of the systems and methods described herein. Processor circuit 302 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 302 may execute program code stored in a computer readable medium, such as program code of operating system 330, application programs 332, other programs 334, etc. Bus 306 represents one or more of any of several types of bus structures, including a memory bus or memory controller, a peripheral bus, an accelerated graphics port, and a processor or local bus using any of a variety of bus architectures. System memory 304 includes read only memory (ROM) 308 and random access memory (RAM) 310. A basic input/output system 312 (BIOS) is stored in ROM 308.

Processor-based computer system 300 also has one or more of the following drives: a hard disk drive 314 for reading from and writing to a hard disk, a magnetic disk drive 316 for reading from or writing to a removable magnetic disk 318, and an optical disk drive 320 for reading from or writing to a removable optical disk 322 such as a CD ROM, DVD ROM, or other optical media. Hard disk drive 314, magnetic disk drive 316, and optical disk drive 320 are connected to bus 306 by a hard disk drive interface 324, a magnetic disk drive interface 326, and an optical drive interface 328, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMS, ROMs, and other hardware storage media.

A number of program modules may be stored on the hard disk, magnetic disk, optical disk, ROM, or RAM. These programs include operating system 330, one or more application programs 332, other programs 334, and program data 336. Application programs 332 or other programs 334 may include, for example, computer program logic (e.g., computer program code or instructions) for implementing the systems described above.

A user may enter commands and information into processor-based computer system 300 through input devices such as keyboard 338 and pointing device 340. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 302 through a serial port interface 342 that is coupled to bus 306, but may be connected by other interfaces, such as a parallel port, game port, or a universal serial bus (USB).

A display screen 344 is also connected to bus 306 via an interface, such as a video adapter 346. Display screen 344 may be external to, or incorporated in processor-based computer system 300. Display screen 344 may display information, as well as being a user interface for receiving user commands and/or other information (e.g., by touch, finger gestures, virtual keyboard, etc.). In addition to display screen 344, processor-based computer system 300 may include other peripheral output devices (not shown) such as speakers and printers.

Processor-based computer system 300 is connected to a network 348 (e.g., the Internet) through an adaptor or network interface 350, a modem 352, or other means for establishing communications over the network. Modem 352, which may be internal or external, may be connected to bus 306 via serial port interface 342, as shown in FIG. 3, or may be connected to bus 306 using another interface type, including a parallel interface.

As used herein, the terms “computer program medium,” “computer-readable medium,” and “computer-readable storage medium” are used to generally refer to physical hardware media such as the hard disk associated with hard disk drive 314, removable magnetic disk 318, removable optical disk 322, other physical hardware media such as RAMs, ROMs, flash memory cards, digital video disks, zip disks, MEMs, nanotechnology-based storage devices, and further types of physical/tangible hardware storage media (including system memory 304 of FIG. 3). Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media.

As noted above, computer programs and modules (including application programs 332 and other programs 334) may be stored on the hard disk, magnetic disk, optical disk, ROM, RAM, or other hardware storage medium. Such computer programs may also be received via network interface 350, serial port interface 342, or any other interface type. Such computer programs, when executed or loaded by an application, enable processor-based computer system 300 to implement features of embodiments discussed herein. Accordingly, such computer programs represent controllers of processor-based computer system 300.

In some embodiments, the system 100 may perform the methods described herein. However, the methods described herein as performed by the system 100 are not meant to be limiting, and any type of software executed on a controller or processor can perform the methods described herein without departing from the scope of this disclosure. For example, a computing system, such as the computing system 300, using a processor executing software within a computing device, can perform the methods described herein.

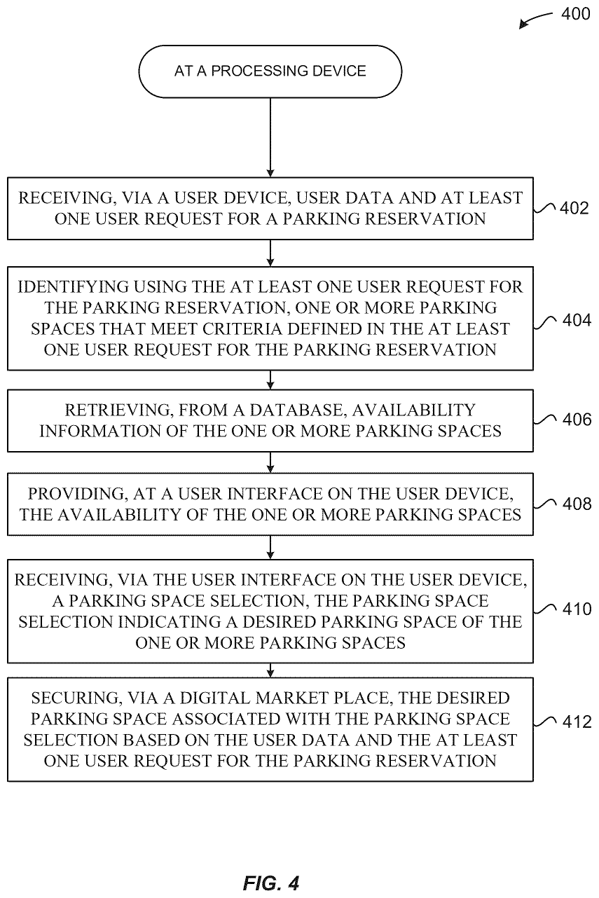

FIG. 4 generally illustrates a parking reservation method 400, according to the principles of the present disclosure, receiving, via a user device, user data and at least one user request for a parking reservation; identifying using the at least one user request for the parking reservation, one or more parking spaces that meet criteria defined in the at least one user request for the parking reservation; retrieving, from a database, availability information of the one or more parking spaces; providing, at a user interface on the user device, the availability of the one or more parking spaces; receiving, via the user interface on the user device, a parking space selection, the parking space selection indicating a desired parking space of the one or more parking spaces; and securing, via a digital market place, the desired parking space associated with the parking space selection based on the user data and the at least one user request for the parking reservation.

In some embodiments, a system includes: a processor; and a memory including instructions that, when executed by the processor, cause the processor to: receive, via a user device, user data and at least one user request for a parking reservation; identify using the at least one user request for the parking reservation, one or more parking spaces that meet criteria defined in the at least one user request for the parking reservation; retrieve, from a database, availability information of the one or more parking spaces; provide, at a user interface on the user device, the availability of the one or more parking spaces; receive, via the user interface on the user device, a parking space selection, the parking space selection indicating a desired parking space of the one or more parking spaces; and secure, via a digital market place, the desired parking space associated with the parking space selection based on the user data and the at least one user request for the parking reservation.

In some embodiments, the desired parking space is associated with a hotel. In some embodiments, the desired parking space is associated with a resort. In some embodiments, the resort includes a ski resort. In some embodiments, the criteria includes at least a duration, a distance relative to a specified location, an arrival time, and a cost range. In some embodiments, the database is disposed remotely from the user device. In some embodiments, the instructions further cause the processor to retrieve, from the database, one or more recommendations based on the user data and the at least one user request for the parking reservation. In some embodiments, the instructions further cause the processor to provide, at the user interface on the user device, the one or more recommendations. In some embodiments, the instructions further cause the processor to receive, via the user interface on the user device, a response to the one or more recommendations. In some embodiments, the instructions further cause the processor to take one or more actions based on the response to the one or more recommendations. In some embodiments, the one or more action includes interaction with a reservation system to reserve a table at a restaurant.

In some embodiments, a method includes: receiving, via a user device, user data and at least one user request for a parking reservation; identifying using the at least one user request for the parking reservation, one or more parking spaces that meet criteria defined in the at least one user request for the parking reservation; retrieving, from a database, availability information of the one or more parking spaces; providing, at a user interface on the user device, the availability of the one or more parking spaces; receiving, via the user interface on the user device, a parking space selection, the parking space selection indicating a desired parking space of the one or more parking spaces; and securing, via a digital market place, the desired parking space associated with the parking space selection based on the user data and the at least one user request for the parking reservation.

In some embodiments, the desired parking space is associated with a hotel. In some embodiments, the desired parking space is associated with a resort. In some embodiments, the resort includes a ski resort. In some embodiments, the criteria includes at least a duration, a distance relative to a specified location, an arrival time, and a cost range. In some embodiments, the database is disposed remotely from the user device. In some embodiments, the method further includes retrieving, from the database, one or more recommendations based on the user data and the at least one user request for the parking reservation. In some embodiments, the method further includes providing, at the user interface on the user device, the one or more recommendations. In some embodiments, the method further includes receiving, via the user interface on the user device, a response to the one or more recommendations

Implementations of the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation to encompass all such modifications and equivalent structure as is permitted under the law.

What is claimed is:

1. A system comprising:
a processor; and
a memory including instructions that, when executed by the processor, cause the processor to:
receive, via a user device, user data and at least one user request for a parking reservation;
identify using the at least one user request for the parking reservation, one or more parking spaces that meet criteria defined in the at least one user request for the parking reservation;
retrieve, from a database, availability information of the one or more parking spaces;
provide, at a user interface on the user device, the availability of the one or more parking spaces;
receive, via the user interface on the user device, a parking space selection, the parking space selection indicating a desired parking space of the one or more parking spaces; and
secure, via a digital market place, the desired parking space associated with the parking space selection based on the user data and the at least one user request for the parking reservation.

2. The system of claim 1, wherein the desired parking space is associated with a hotel.

3. The system of claim 1, wherein the desired parking space is associated with a resort.

4. The system of claim 3, wherein the resort includes a ski resort.

5. The system of claim 1, wherein the criteria includes at least a duration, a distance relative to a specified location, an arrival time, and a cost range.

6. The system of claim 1, wherein the database is disposed remotely from the user device.

7. The system of claim 1, wherein the instructions further cause the processor to retrieve, from the database, one or more recommendations based on the user data and the at least one user request for the parking reservation.

8. The system of claim 7, wherein the instructions further cause the processor to provide, at the user interface on the user device, the one or more recommendations.

9. The system of claim 8, wherein the instructions further cause the processor to receive, via the user interface on the user device, a response to the one or more recommendations.

10. The system of claim 9, wherein the instructions further cause the processor to take one or more actions based on the response to the one or more recommendations.

11. The system of claim 10, wherein the one or more action includes interaction with a reservation system to reserve a table at a restaurant.

12. A method comprising:
receiving, via a user device, user data and at least one user request for a parking reservation;
identifying using the at least one user request for the parking reservation, one or more parking spaces that meet criteria defined in the at least one user request for the parking reservation;
retrieving, from a database, availability information of the one or more parking spaces;
providing, at a user interface on the user device, the availability of the one or more parking spaces;
receiving, via the user interface on the user device, a parking space selection, the parking space selection indicating a desired parking space of the one or more parking spaces; and
securing, via a digital market place, the desired parking space associated with the parking space selection based on the user data and the at least one user request for the parking reservation.

13. The method of claim 1, wherein the desired parking space is associated with a hotel.

14. The method of claim 1, wherein the desired parking space is associated with a resort.

15. The method of claim 14, wherein the resort includes a ski resort.

16. The method of claim 1, wherein the criteria includes at least a duration, a distance relative to a specified location, an arrival time, and a cost range.

17. The method of claim 1, wherein the database is disposed remotely from the user device.

18. The method of claim 1, further comprising retrieving, from the database, one or more recommendations based on the user data and the at least one user request for the parking reservation.

19. The method of claim 18, further comprising providing, at the user interface on the user device, the one or more recommendations.

20. The method of claim 19, further comprising receiving, via the user interface on the user device, a response to the one or more recommendations.
